(19) United States
(12) Patent Application Publication
(10) Pub. No.: US 2009/0049180 A1
(43) Pub. Date: Feb. 19, 2009

(54) GATEWAY APPARATUS

(76) Inventors: Nami EI, Yokohama (JP); Hirofumi Masukawa, Isehara (JP); Hitoshi Yoshida, Yokohama (JP); Kazuma Yumoto, Fuchu (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/184,352

(22) Filed: Aug. 1, 2008

(30) Foreign Application Priority Data
Aug. 15, 2007 (JP) 2007-211708

(51) Int. Cl. G06F 15/16

(52) U.S. Cl. 709/227

(57) ABSTRACT

Even when all of usable sessions are in use, a communication can be established for a new session and the interrupted session is automatically restored. Information on degrees of importance of communication sessions and information of restoration requirement are set in advance and stored in a session importance table in association with identifier (URI) of communication initiating terminals and identifier of destinations of communication. When a connection request for a session having a high degree of importance such as an emergency session is received, the session having the lowest degree of importance is selected and interrupted. Information of the interrupted session such as the communication initiator identifier and the communication destination identifier is stored in a session restoration table. The session is automatically restored as soon as a session resource becomes unoccupied according to the communication initiator identifier and the communication destination identifier stored in the session restoration table.

### BACKGROUND OF THE INVENTION

1. Field of the Invention

The present invention relates to a gateway apparatus and, more particularly, to a gateway apparatus for establishing connection for a particular new session when all available sessions are in use.

2. Description of the Related Art

In the disclosure of Patent Document 1, it is proposed to disconnect a physical channel to allow a new urgent call to be placed when no channel resource is available in an ISDN network (when both B channels are in use). For example, according to the disclosure of Patent Document 1, when a call is determined to be a priority call, the contact of a relay is opened to disconnect an I interface channel connected from a line termination apparatus to a plurality of ISDN communication terminals.

Known approaches to responding to a connection request from a user terminal given a high priority include disconnecting other sessions of lower priorities (for example, see Patent Documents 2 to 5).

Patent Document 1: JP-A-11-266324

Patent Document 2: JP-A-2006-148648

Patent Document 3: JP-A-10-111853

Patent Document 4: JP-A-2003-16031

Patent Document 5: JP-A-2004-187094

### SUMMARY OF THE INVENTION

According to the technique disclosed in Patent Document 1, all channels in use are disconnected without distinction made by comparing the degrees of importance of communication over the channels to select channels, and some of the channels are therefore unnecessarily disconnected. As a result, the efficiency of the communication channels can be reduced. In any of the techniques disclosed in Patent Document 1 to 5, no consideration is paid to how to identify and automatically resume communication which has been interrupted when a channel becomes unoccupied. As a result, a user must carry out a time-consuming manual operation to re-establish a connection.

When a user terminal having a high priority remains connected in such a case, a connection permit may not be granted to a user having a lower priority even if the user having a lower priority tries to re-establish a connection. Thus, the user has to try to re-establish a connection many times, which takes a great deal of time and labor. Since the timing at which a user tries to re-establish a connection is unrelated to the interruption and release of a session, there may be an idle time before a user tries to re-establish a connection after a session at another user terminal having a higher priority is interrupted and released. Therefore, the efficiency of utilization of the channel is low.

The invention confronts the above-described problem, and it is an object of the invention to provide a gateway apparatus which allows a connection to be established for a new session having a high degree of importance by interrupting one of sessions in progress even if all available sessions are in use and allows the interrupted session to be automatically restored.

According to the invention, the session having the lowest degree of importance among existing communication sessions is selected and interrupted, the selection being made based on, for example, degrees of importance of the sessions which are set in advance using parameters such as communication initiating terminals and parties to which communication is established.

According to the invention, for example, information on an interrupted communication session is stored in a session initiation protocol (SIP) gateway depending whether re-connection is required or not, such a requirement being set in advance along with the degree of importance of the session. Thus, the communication is automatically re-established as soon as a session resource becomes unoccupied.

One feature of the SIP gateway is that it includes a session monitoring unit for real-time monitoring of the statues of a communication session in progress, connected to an IP network utilizing SIP, a session control unit for connecting and disconnecting a session, a session restoring unit for restoring a disconnected section, a channel control unit for managing routing of a communication packet, a channel interface unit for transferring a communication packet, a session status table for storing information on the status of a communication session in progress, a session resource table for storing information on usable session resources and the status of consumption of the same, a session importance table for storing information on the degree of importable a session, and a session restoration table for storing information on a session which has been disconnected and which must be restored.

Another feature of the SIP gateway is as follows. Let us assume that a new session connection request is made by a terminal set at the highest degree of importance (e.g., a terminal for urgent report) of a subscriber connected to an IP network utilizing SIP when all of sessions are occupied or the maximum number of sessions defined in a subscription service contract has been reached. Then, the SIP gateway allows a connection to be established for the new session by selecting and interrupting the session having the lowest degree of importance among the existing communication sessions based on degrees of importance of the sessions which are set in advance using the communication initiating terminals and the called parties as parameters.

Another feature of the SIP gateway is that a connection is automatically re-established for the existing session which has been interrupted as described above as soon as a session resource of the SIP gateway becomes unoccupied depending on whether re-connection is required or not, such a requirement being set in advance along with a degree of importance.

Still another feature of the SIP gateway is that a degree of importance as described above can be arbitrarily set by a user.

According to the solving means of this invention, there is provided a gateway apparatus, in a system in which a session is established between a terminal and apparatus at destination of communication through a network, disposed between a plurality of the terminals and the network and set the number of usable sessions in advance, the gateway apparatus comprising:

a session importance storage area in which degrees of importance of the sessions are stored in advance in association with a communication initiator identification information of the sessions and a communication destination identification information;

a session status storage area in which the communication initiator identification information and the communication destination identification information are stored for one session or each of a plurality of sessions in progress;

a session restoration storage area in which the communication initiator identification information and the communication destination identification information of a session which are interrupted are stored;

a session restoration unit restoring a session between apparatuses indicated by the communication initiator identification information and the communication destination identification information stored in the session restoration storage area; and

a session control unit controlling a establishment and an interruption of the session,

wherein, the session control unit,

when a connection request for a new session including the communication initiator identification information and the communication destination identification information indicating one of the terminals is received from the terminal in a state which the number of sessions in progress is equal to the number of usable sessions,

refers to the session status storage area to identify the communication initiator identification information and the communication destination identification information for one or plurality of sessions which has already been established,

refers to the session importance storage area based on identified communication initiator identification information and identified communication destination identification information to obtain the degree of importance for each of the sessions in progress,

selects the session having the lowest degree of importance or one of sessions having degrees of importance lower than a predetermined reference,

interrupts the selected session,

stores the communication initiator identification information and the communication destination identification information of the selected session in the session restoration storage area, and

establishes a new session between the terminal of communication initiator and the apparatus at the communication destination according to the communication initiator identification information and the communication destination identification information included in the connection request for the new session,

further wherein,

the session restoration unit and/or the session control unit establishes a session between the terminals or apparatus indicated by the communication initiator identification information and the communication destination identification information stored in the session restoration storage area when a session becomes usable as a result of a disconnection of the new session or another session, whereby restoring the interrupted session.

According to this invention, it can provide a gateway apparatus which allows a connection to be established for a new session having a high degree of importance by interrupting one of sessions in progress even if all available sessions are in use and allows the interrupted session to be automatically restored.

### BRIEF DESCRIPTION OF THE DRAWINGS

FIG. 1 is a conceptual diagram of a configuration of a network including an SIP gateway apparatus;

FIG. 2 is a conceptual illustration of an internal configuration of the SIP gateway apparatus;

FIG. 3 is a flow chart of processes performed by the SIP gateway apparatus in response to a new session connection request;

FIG. 4 shows a configuration of a session resource table for storing information on usable session resources and the state of consumption of the same;

FIG. 5 shows a configuration of a session importance table for storing information on degrees of importance of sessions;

FIGS. 6A to 6C show a configuration of a session status table for storing information on the status of sessions in progress;

FIG. 7 is a flow chart of processes to restore a session which has been interrupted and which must be restored;

FIGS. 8A and 8B show a configuration of a session restoration table for storing information on a session which has been interrupted and which must be restored;

FIG. 9 is a flow chart of restoration processes performed by a session control unit; and

FIG. 10 is a diagram showing a sequence of operations performed when a connection request for an urgent session having the highest degree of importance is issued by a terminal UA-C in a state in which two sessions or the maximum number of sessions is used up by communication between a terminal UA-A and a communication destination UA-a and between a terminal UA-B and a communication destination UA-b.

### DETAILED DESCRIPTION OF THE INVENTION

### Hardware Configuration

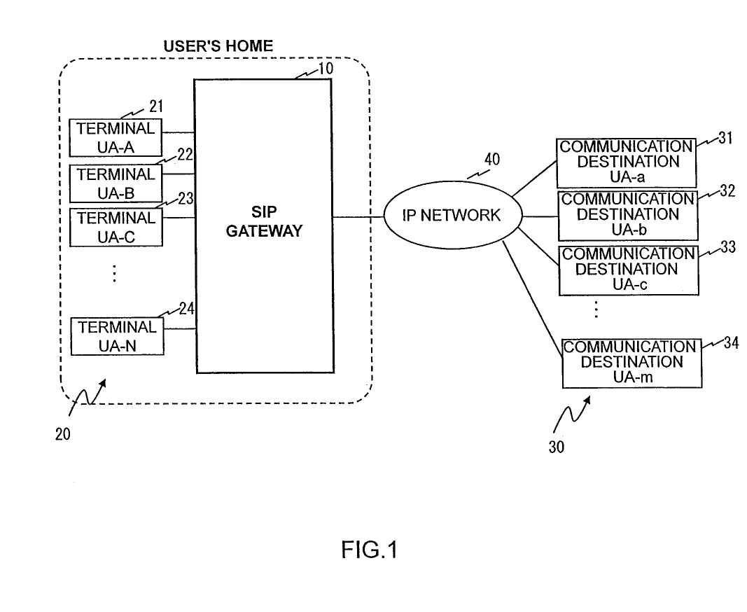

FIG. 1 is a conceptual diagram of a configuration of a network including an SIP gateway.

For example, the network system includes a plurality of terminals UA20 (e.g., terminals UA-A21 to UA-N24), an SIP gateway apparatus 10, and one or a plurality of apparatus UA30 (e.g., destinations UA-a31 to UA-m34) at destinations of communication. Although the present embodiment is described on an assumption that SIP is used by way of example, other protocols may be used. It is not essential that the terminals UA20 and the communication destination apparatus UA30 are physical terminals and apparatus, and they may be logical applications.

For example, the SIP gateway apparatus 10 is installed in the house of a subscriber (user) and is provided between the home terminals UA20 and an IP network 40. For example, the apparatus may be provided at a boundary between the home network and the public network 40. Connection is established for sessions between the terminals UA20 and the communication destination apparatus UA30 through the IP network 40 and the SIP gateway apparatus 10. In such a network configuration, a maximum number of sessions that can be used in the house is prescribed in a subscription service contract that the subscriber has made (it is assumed that the maximum number of sessions is two).

The communication destination apparatus UA30 may include a server which distributes video streams, a television conference server, a terminal for audio-visual communication, and a server for security monitoring (a security center).

The terminals UA20 may include a personal computer, a telephone set, a set-top box, and a sensor and a controller for security monitoring. The invention is not limited to such terminals, and other appropriate terminals and apparatus may be used.

The set-top box may receive a video stream, for example, from a communication destination apparatus UA30 which distributes video streams. The telephone set may perform audio-visual communication with a communication destination apparatus UA30. The personal computer may be connected to, for example, a communication destination apparatus UA30 to hold a television conference. For example, the personal computer communicates with a television conference server installed at a company. The personal computer may have the same function as the above-described set-top box or television set.

The sensor for security monitoring may be mounted on a door or provided in the vicinity of the door to detect the invasion of a suspicious person. Alternatively, the sensor may be a sensor for security or a sensor for detecting a fire, a gas leak or an electrical leak. The sensor may alternatively be a switch for issuing an emergency alarm in a nursing or medical application. When an abnormality such as the invasion of a suspicious personal is detected, the controller (which may be, for example, the terminal UA-C23) for controlling the sensor for security monitoring provides a security monitoring server (which may be, for example, the communication destination apparatus UA-c33) with information indicating the abnormality. In the present embodiment, an urgent session associated with security is connected with priority even when connections have already been occupied by other sessions. For example, even when the subscriber is at home and using all available sessions through the telephone set and the personal computer, a connection can be established for the session associated with security to provide a server for security monitoring (e.g., a security center) with the information indicating the abnormality.

A URI (identification information) is assigned to each of the terminals UA20 and the communication destination apparatus UA30. The application URIs is not limited to physical terminals and apparatus, and they may be assigned to applications.

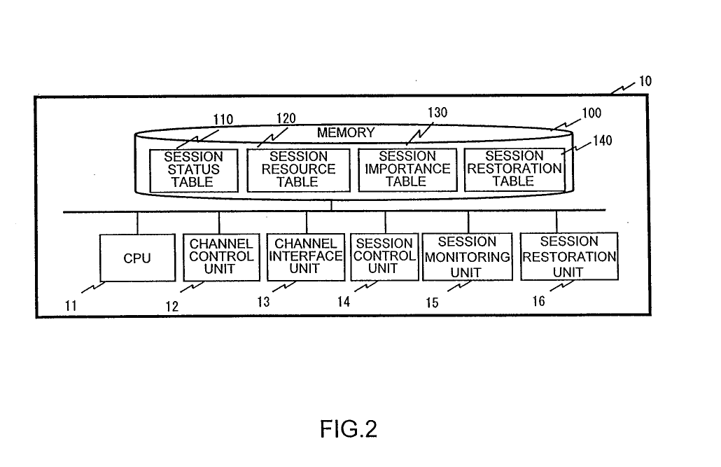

FIG. 2 is a conceptual illustration of an internal configuration of the SIP gateway apparatus 10.

For example, the SIP gateway apparatus 10 includes a CPU 11, a channel control unit 12, a channel interface unit 13, a session control unit 14, a session monitoring unit 15, a session restoration unit 16, and a memory 100. For example, the memory 100 includes a session status table (a session status storage area) 110, a session resource table (a session resource storage area) 120, a session importance table (a session importance storage area) 130, and a session restoration table (a session restoration storage area) 140. Those units are connected through a bus.

The channel control unit 12 manages the routing of a communication packet. The channel interface unit 13 is an interface for transferring a communication packet. The session control unit 14 controls interruption and connection of a session. The session monitoring unit 15 is provided for real time monitoring of the status of sessions in progress. For example, the session monitoring unit 15 monitors sessions and stores the number of sessions in progress in the session resource management table. The session restoration unit 16 restores a session which has been interrupted. For example, when there is an vacancy available for a session, the session restoration unit 16 causes the session control unit 14 to restore a session between apparatus indicated by a terminal UA URI (communication initiator URI or communication initiator identification information) and a communication destination UA URI (communication destination identification information) stored in the session restoration table 140.

Information on the status of sessions in progress is stored in the session status table 110. The number of usable session resources and information on the status of resource consumption is stored on the session resource table 120. Information on preset degrees of importance of sessions is stored in the session importance table 130. Information on a session which has been interrupted and which must be restored is stored in the session restoration table 140. The configuration of each of the tables will be described later in detail.

### (Configurations of the Tables)

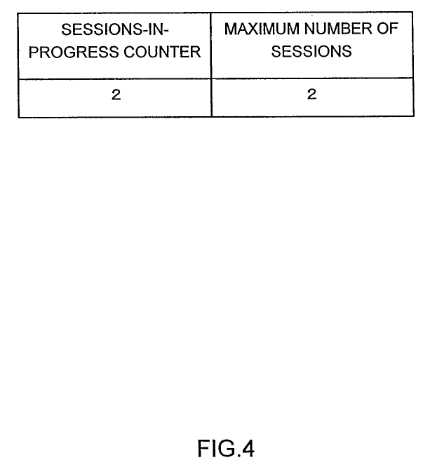

FIG. 4 shows a configuration of the session resource table 120.

For example, the session resource table 120 includes a maximum number of sessions defined in a service contract between a user and a carrier and a sessions-in-progress counter which indicates the status of consumption of session resources. The sessions-in-progress counter is incremented or decremented when a session is connected or interrupted.

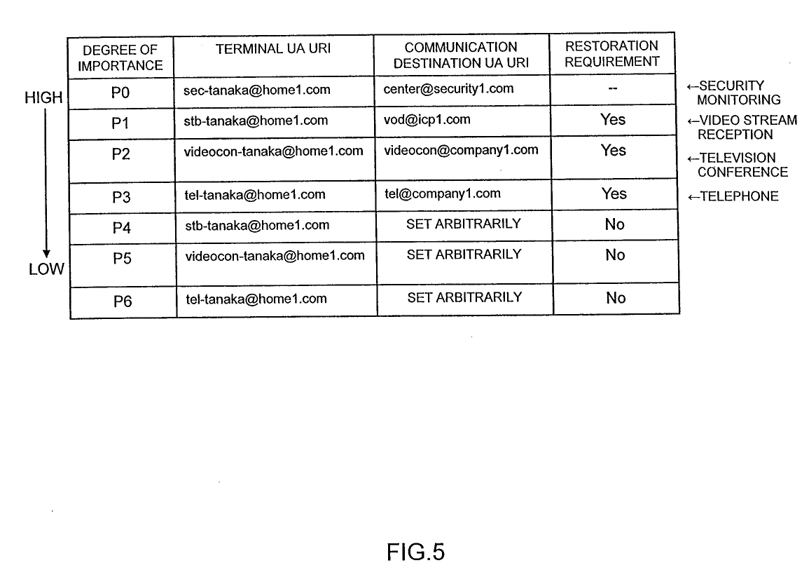

FIG. 5 shows a configuration of the session importance table 130 for storing information on degrees of importance of sessions.

The session importance table 130 may be arbitrarily set by a user. For example, the session importance table 130 includes terminal UA URIs, communication destination UA URIs, information on degrees of importance, and restoration requirement information.

The terminal UA URIs are identification information for identifying a plurality of terminals UA20 which are connected to the SIP gateway apparatus 10 and which are associated with different applications, respectively. The communication destination UA URIs are identification information for identifying communication destination UA30. The restoration requirement information defines whether restoration is required for a session which has been interrupted by force. A user may arbitrarily make a setting on whether to restore or not. The restoration requirement information may be omitted.

The illustrated example is based on an assumption that there are degrees of importance P0 to P6 in the descending order of importance. P0 represents the highest degree of importance, and a transmission request at this degree of importance must be met without fail. For example, the degree of importance P0 is set for a session for security monitoring in this case. The degree of importance may alternatively be assigned to an urgent session such as a 911 call. Although one session has the degree of importance P0 in this example, the degree may be assigned to a plurality of sessions.

P1 to P6 represent the order in which various sessions are to be interrupted (the priorities of the sessions) when interruption is required. Sessions are interrupted in an order starting with P6 and ending with P1. In the illustrated example, P1 is assigned to a session for receiving a video stream from a particular server (e.g., a pay contents server); P2 is assigned to a session for a television conference with a company; P3 is assigned to a telephone session with a company; P4 is assigned to a session for receiving a video stream from an arbitrary server; P5 is assigned to a session for a television conference with an arbitrary party; and P6 is assigned to a telephone session with an arbitrary party.

A session for receiving a video stream from a pay contents server may be charged double, for example, when the session is interrupted half way and retried to download the contents from the beginning by establishing the connection again. In this example, a high degree of importance is set for a session for receiving a video stream from a pay contents server, and such double charging can therefore be avoided.

It is not essential to fix the number of degrees of importance at seven levels as shown, and the number may be arbitrarily set by a user.

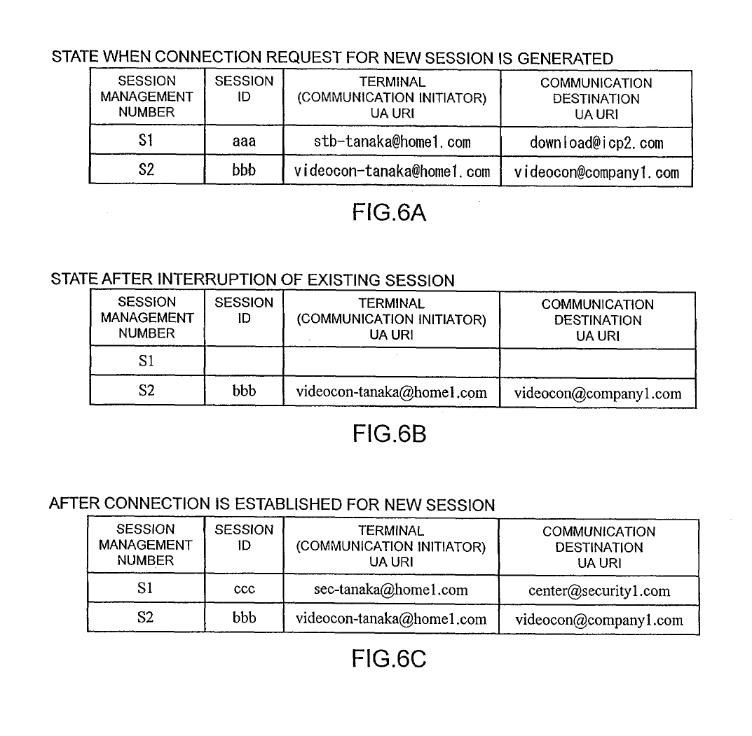

FIGS. 6A to 6C show a configuration of the session status table 110 for storing information on the status of sessions in progress.

The session status table 110 includes (fixed) session management numbers used for internal identification of sessions, session IDs (call IDs) each of which is uniquely generated each time a session occurs; the URIs of terminals UA initiating sessions, and URIs of communication destinations UA. The session status table 110 of this example is based on an assumption that the maximum number of sessions is two.

FIG. 6A shows an example of a state of the table in which the maximum number of sessions has already been reached by sessions in progress. Referring to the session having a session management number S1 in this example, the terminal UA-A21 (URI: stb-tanaka@home1.com) which is a set-top box and the communication destination UA-a31 (URI: download@icp2.com) which is a video distribution server are connected through a session having a session ID aaa. Referring to the session having a session management number S2, the terminal UA-B22 (URI: videocon-tanaka@home1.com) which is a personal computer and the communication destination UA-b32 (URI:Videocon@company1.com) which is a television conference server are connected through a session having a session ID bbb.

FIG. 6B shows a state of the table after the session having the session management number S1 is interrupted.

FIG. 6C shows a state of the table in which information on a new session is stored in the line of S1 after the new session is established. Referring to the new session, the terminal UA-C23 (URI: sec-tanaka@home1.com) for security monitoring and the communication destination UA-c33 (URI: center@security1.com) which is a server at a security center are connected through a session having a session ID ccc. Details of processes associated with transitions from the state in FIG. 6A to the state in FIG. 6C will be described later.

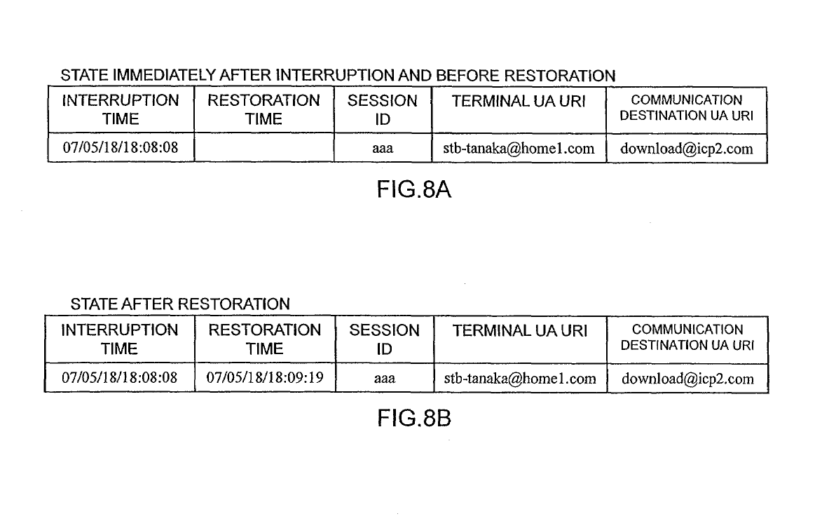

FIGS. 8A and 8B show a configuration of the session restoration table 140 for storing information on a session which has been interrupted and which must be restored.

For example, the session restoration table 140 includes a field named “interruption time” for storing information on the time at which a session has been interrupted, a field named “restoration time” for storing information on the time at which the session has been restored, and the session ID, the terminal UA URI, and the communication destination UA URI associated with the interrupted session. Information on the time at which the session has been restored by the session control unit 14 is input in the “restoration time” field.

### (Session Connecting Process)

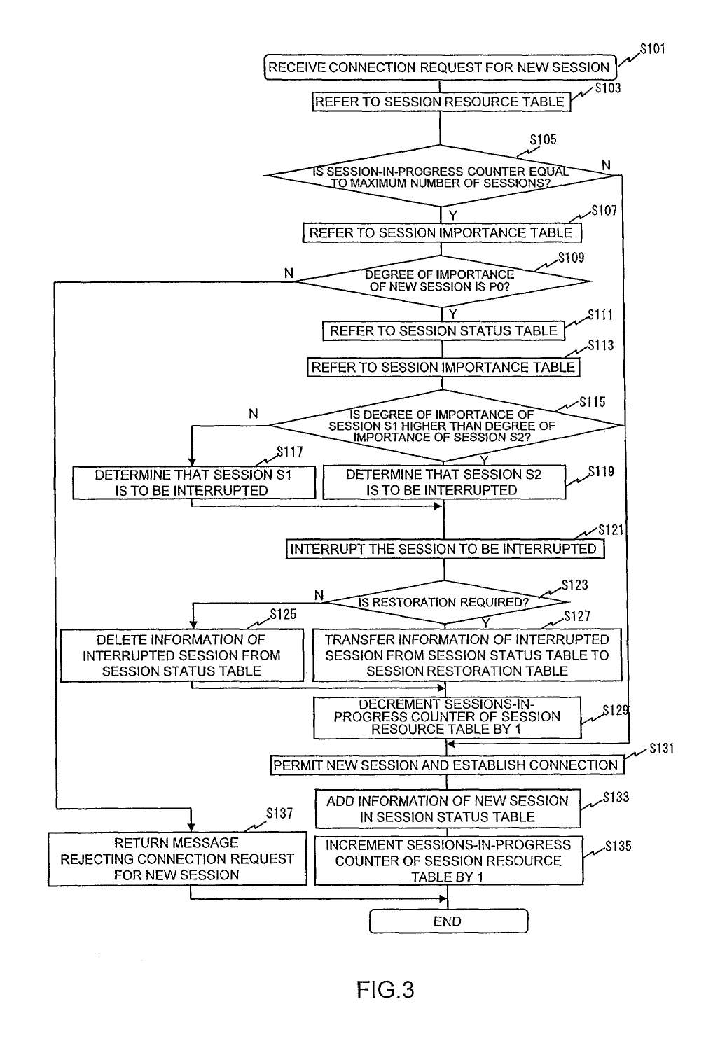

FIG. 3 is a flow chart of processes performed by the session control unit 14 in response to a new session connection request.

First, a terminal UA20 transmits a connection request for anew session to the SIP gateway apparatus 10, the request including the terminal UA URI of the terminal (communication initiator URI) and the URI of the communication destination UA (communication destination URI). For example, the terminal UA-C23 transmits a connection request for a new session. A connection request for a new session may further include a session ID.

The session control unit 14 of the SIP gateway apparatus 10 receives the connection request for a new session from the terminal UA20 through the channel interface unit 13 (S101). The session control unit 14 retrieves the session resource table 120 to determine whether there is a session resource to be allocated to the new session (S103). For example, with reference to the session resource table 120, the session control unit 14 proceeds to step S107 when the number of sessions in progress agrees with the maximum number of sessions (there is no unoccupied resource) (step S105: Yes) and otherwise (when there is an unoccupied resource or step S105 results in No) proceeds to step S131.

At step S107, the session control unit 14 retrieves the session importance table 130 based on the communication initiator URI and the communication destination URI included in the connection request for the new session to find the degree of importance associated with the same (S107). The session control unit 14 determines whether the requested new session has the highest degree of importance (P0) (S109). When the degree of importance of the requested session is not P0 (S109: No), the session control unit 14 returns a session connection reject message to the terminal UA20 (S137). When the degree of importance of the request session is P0 (S109: Yes), the process proceeds to step S111. Alternatively, the process may proceed to step S111 when the degree of importance of the requested session is higher than a predetermined reference although the degree of importance is not P0 (not highest).

At step S111, the session control unit 14 retrieves the session status table 110 to acquire the communication initiator URIs and communication destination URIs associated with existing sessions (S111). The session control unit 14 checks the session importance table 130 based on the acquired communication initiator URIs and the communication destination URIs to acquire the session importance information and restoration requirement information (whether restoration is required or not) of the sessions (S113). The session control unit 14 performs the processes at steps S111 and S113 for all of the existing sessions to acquire the session importance information and restoration requirement information of each of the sessions in connection.

The session control unit 14 compares the degrees of importance of the sessions thus acquired to identify the session having the lowest degree of importance (S115 to S119). Alternatively, the session control unit 14 may identify one of sessions whose degrees of importance are lower than a predetermined reference.

The session control unit 14 interrupts the session thus identified (S121). According to the restoration requirement information of the interrupted session, the session control unit 14 determines whether it is required to restore the session or not (S123).

When the interrupted session must be restored (S123: Yes), the session control unit 14 transfers information associated with the session from the session status table 110 to the session restoration table 140 and saves the information in the same (S127). More specifically, when the restoration requirement information acquired at step S113 indicates that restoration is required, the session control unit 14 reads the communication initiator URI and the communication destination URI associated with the identified session from the session status table 110 and stores the URIs in the session restoration table 140 and deletes the communication initiator URI and the communication destination URI from the session status table 110.

When restoration is not required for the interrupted session (S123: No), the session control unit 14 deletes the communication initiator URI and the communication destination URI associated with the session from the session status table 110 (S125).

At step S129, the session control unit 14 (or the session monitoring unit 15) updates the session resource table 120 (S129). For example, the session control unit 14 decrements the sessions-in-progress counter of the session resource table 120 by 1.

The session control unit 14 grants a permit for the new session and establishes a connection for the same (S131). For example, the session control unit 14 establishes a connection for the new session between the communication initiating terminal UA and the communication destination UA according to the communication initiator URI and the communication destination URI included in the connection request for the new session. The session control unit 14 stores the communication initiator URI, the communication destination URI, and a session ID in the session status table 110. An arbitrary session ID may be assigned. The session control unit 14 increments the sessions-in-progress counter of the session resource table 120 by 1 (S135).

### (Session Restoration Process)

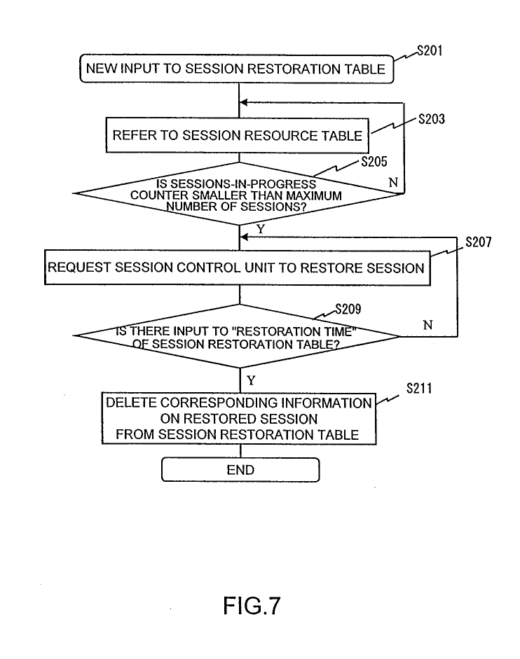

FIG. 7 is a flow chart of processes to restore an interrupted session performed by the session restoration unit 16.

When there is a new input to the session restoration table 140 (S201 which corresponds to S127 in FIG. 3), the session restoration unit 16 retrieves the session resource table 120 (S203) to check whether there is an unoccupied resource or not (S205). For example, the session restoration unit 16 may determine that there is an unoccupied resource when the value of the sessions-in-progress counter of the session resource table 120 is smaller than the maximum number of sessions and may determine that there is no unoccupied resource when the value of the sessions-in-progress counter of the session resource table 120 is not smaller than the maximum number of sessions.

When there is no unoccupied resource (S205: No), the session restoration unit 16 retrieves the session resource table 120 again, for example, after a predetermined time passes to check whether an unoccupied resource has become available or not (S203, S205). When there is an unoccupied resource (S205: Yes), the session restoration unit 16 transmits information on the session to be restored to the session control unit 14 and request the same to perform a restoration process (S207). According to the request, the session control unit 14 performs a session restoration process which will be described later. When the session is successfully restored by the session restoration process, the session control unit 14 inputs the actual time of restoration in the “restoration time” field of the session restoration table 140 (step S317 which will be described later).

The session restoration unit 16 checks whether there is an input (stored data) in the “restoration time” field of the session restoration table 140 (S209). When there is no input in the “restoration time” field (S209: No), the session restoration unit 16 requests the session control unit 14 again to perform the restoration process (S207). When there is an input in the “restoration time” field (S209: Yes), the session restoration unit 16 deletes information on the session from the session restoration table 140 (S211).

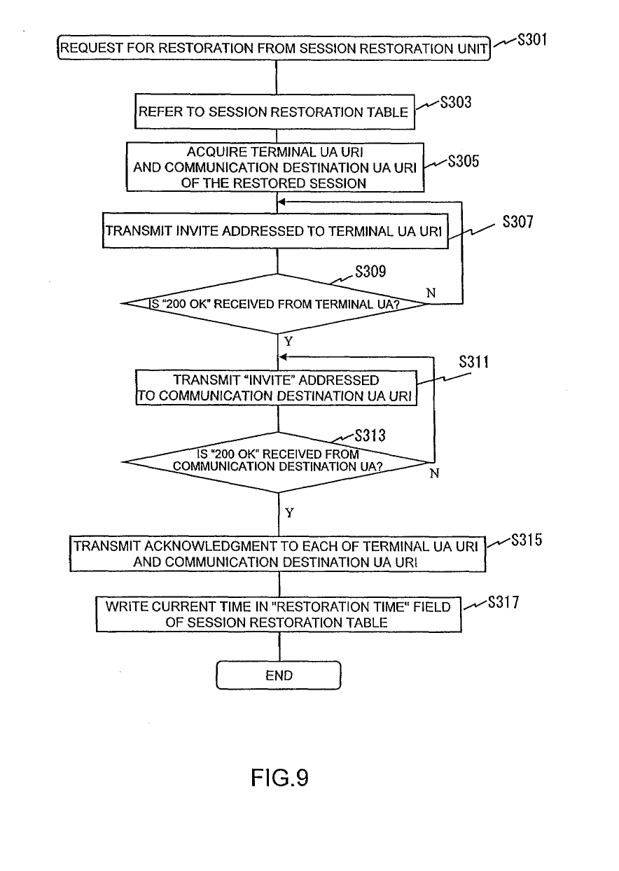

FIG. 9 is a flow chart of the session restoration processes performed by the session control unit 14.

The session control unit 14 receives a restoration request from the session restoration unit 16 (S301, S207 in FIG. 7). The session control unit 14 retrieves the session restoration table 140 (S303) to acquire the relevant terminal UA URI and communication destination UA URI (S305). The session control unit 14 transmits an “INVITE” message addressed to the terminal UA URI thus acquired (S307). The session control unit 14 determines whether a “200 OK” (200 acceptance) message has been received from the terminal UA (S309). When the acceptance has not been received, the “INVITE” message is transmitted again (S307). When the acceptance has been received, the process proceeds to step S311.

The session control unit 14 transmits an “INVITE” message addressed to the communication destination UA URI acquired as described above (S311). For example, the “INVITE” message includes the acquired terminal UA URI (communication initiator URI) and communication destination UA URI. The session control unit 14 determines whether a “200 OK” message has been received from the communication destination UA (S313). When the acceptance has not been received, the “INVITE” message is transmitted again (S311). When the acceptance has been received, the process proceeds to step S315.

The session control unit 14 transmits an acknowledgement message to each of the terminal UA and the communication destination UA (S315). A connection is reestablished for the session stored in the session restoration table 140 through the above-described processes. The session control unit 14 writes the current time in the “restoration time” field of the session restoration table 140 (S317).

Although the restoration process is performed separately by the session control unit 14 and the session restoration unit 16 in this embodiment, the process may alternatively be performed by a single control unit.

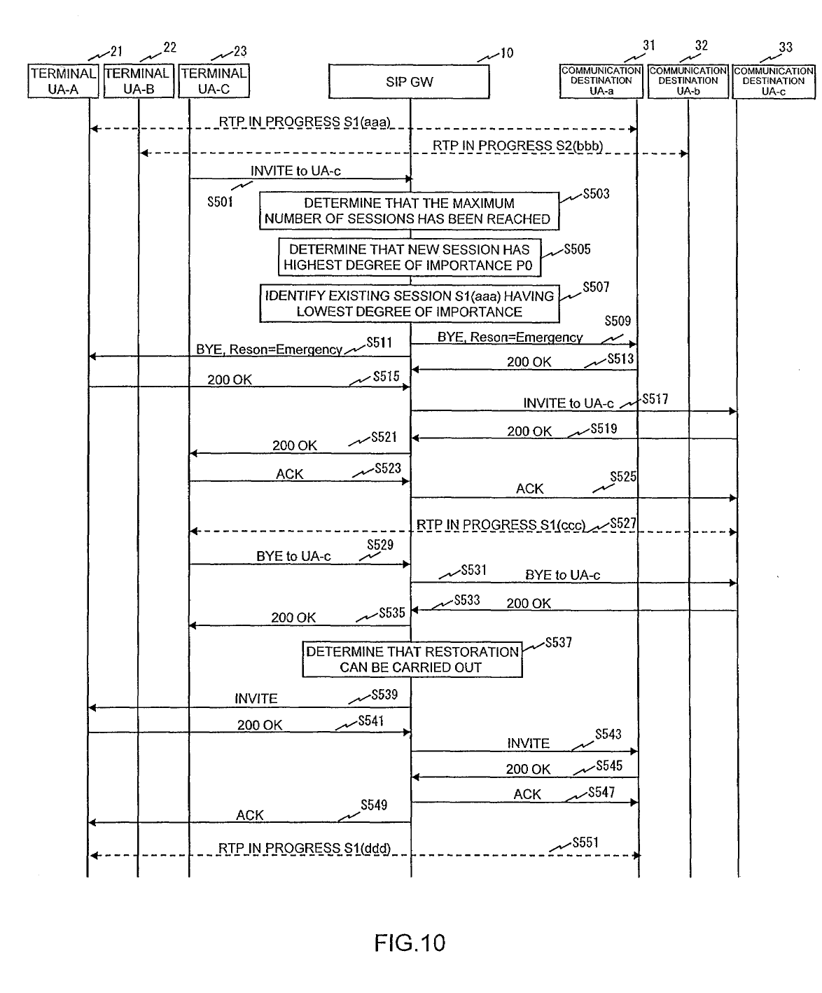

FIG. 10 is a communication sequence diagram.

The diagram shows a sequence of operations performed, for example, when a connection request for an urgent session having the highest degree of importance is issued by the terminal UA-C23 in a state in which two sessions or the maximum number of sessions is used up by communication between the terminal UA-A21 and the communication destination UA-a31 and between the terminal UA-B22 and the communication destination UA-b32.

Sessions numbered S1 (session ID aaa) and S2 (session ID bbb) have been established and is in progress between the terminal UA-A21 and the communication destination UA-a31 and between the terminal UA-B22 and the communication destination UA-b32. At this time, the session status table 110 is in the state shown in FIG. 6A.

The terminal UA-C23 transmits a session connection request (“INVITE” message) addressed to the communication destination UA-c33 to the SIP gateway apparatus 10 (S501). For example, the session connection request includes the terminal UA URI of the terminal UA-C23 (sec-tanaka@home1.com) in a “From” header thereof and the communication destination UA URI of the communication destination UA-c33 (center@security.com) in a “To” header thereof.

The SIP gateway apparatus 10 refers to the session resource table 120, and the apparatus determines that the number of sessions in progress has reached the maximum number of sessions in this case (S503 which corresponds to S103 and S105 in FIG. 3).

The SIP gateway apparatus 10 refers to the session importance table 130, and the apparatus determines that the degree of importance of the new session is P0 that is the maximum value in this case (S505 which corresponds to S107 and S109 in FIG. 3).

The SIP gateway apparatus 10 identifies the session S1 (aaa) as the existing session having the lowest degree of importance (S507 which corresponds to S111 to S119 in FIG. 3). It is found by referring to the session status table 110 and the session importance table 130 that the session having the session management number S1 has the degree of importance P4 and that the session having the session management number S2 has the degree of importance P2. Therefore, the SIP gateway apparatus 10 identifies the session having the session management number S1 as a session having a lower degree of importance.

A “BYE” message (interruption request) is transmitted from the SIP gateway apparatus 10 to each of the terminal UA-A21 and the communication destination UA-a31 according to the communication initiator URI and communication destination URI associated with the session management number S1 in the session status table 110 to initiate a session interrupting process (S509, S511). The “BYE” message may include a line stating “reason=emergency” as a reason for the interruption. The SIP gateway apparatus 10 receives a “200 OK” message from the terminal UA-A21 and the communication destination UA-a31 (S513, S515).

When restoration is required, the SIP gateway apparatus 10 stores the communication initiator URI and the communication destination URI associated with the session management number S1 shown in the session status table 110 in the session restoration table 140 and writes the interruption time in the same (S127 in FIG. 3). The SIP gateway apparatus 10 deletes the entry of the session management number S1 from the session status table 110 (S127, S125 in FIG. 3). For example, the table 110 has contents as shown in FIG. 6B after the deletion.

After the session S1 (session ID aaa) thus identified is interrupted, the SIP gateway apparatus 10 transmits an “INVITE” message to the communication destination UA-c33 of the new session to establish a session S1 (session ID ccc) between the terminal UA-C23 and the communication destination UA-c33 (S517 to S525 which correspond to S131 in FIG. 3).

Communication is established between the terminal UA-C23 and the communication destination UA-c33 through the above-described processes (S527).

After communication through the new session S1 (session ID ccc) is performed, in order to terminate the session, a “BYE” message is transmitted from the terminal UA-C23 to the SIP gateway apparatus 10 and from the SIP gateway apparatus 10 to the communication destination UA-c33 (S529, S531). The SIP gateway apparatus 10 receives a “200 OK” message from the communication destination UA-c33 and transmits the same to the terminal UA-C23 (S533, S535). Thus, a session resource equivalent to the session S1 is released.

When it is determined that there is an unoccupied session from the release of the new session resource (the interruption of the session) or interruption of another session, the session restoration unit 16 transmits a restoration request to the session control unit 14, and the SIP gateway apparatus 10 determines that restoration can be carried out (S537).

An “INVITE” message is transmitted from the SIP gateway apparatus 10 to each of the terminal UA-A21 and the communication destination UA-a31 based on the information stored in the session restoration table 140 to initiate the restoration process (S539 to S549).

As a result, the session between the terminal UA-A21 and the communication destination UA-a31 which has been interrupted is restored in the form of a session S1 (session ID ddd).

For example, the invention may be applied to gateway apparatus and systems in which communication is performed between terminals and apparatus through a gateway apparatus.

What is claimed is:

1. A gateway apparatus to be disposed between a plurality of terminals and a network in a system in which a session is established between the terminal and an apparatus at destination of communication through the network and, set the number of usable sessions in advance, the gateway apparatus comprising:
a session importance storage area in which degrees of importance of the sessions are stored in advance in association with a communication initiator identification information and a communication destination identification information of the sessions;
a session status storage area in which the communication initiator identification information and the communication destination identification information are stored for one session or each of a plurality of sessions in progress;
a session restoration storage area in which the communication initiator identification information and the communication destination identification information of a session which is interrupted are stored;
a session restoration unit restoring the session between apparatuses indicated by the communication initiator identification information and the communication destination identification information stored in the session restoration storage area; and
a session control unit controlling a establishment and an interruption of the session,
wherein, the session control unit,
when a connection request for a new session including the communication initiator identification information and the communication destination identification information indicating one of the terminals is received from the terminal in a state which the number of sessions in progress is equal to the number of usable sessions,
refers to the session status storage area to identify the communication initiator identification information and the communication destination identification information for one or plurality of sessions which has already been established,
refers to the session importance storage area based on identified communication initiator identification information and identified communication destination identification information to obtain the degree of importance for each of the sessions in progress,
selects the session having the lowest degree of importance or one of sessions having degrees of importance lower than a predetermined reference,
interrupts the selected session,
stores the communication initiator identification information and the communication destination identification information of the selected session in the session restoration storage area, and
establishes a new session between the terminal of communication initiator and the apparatus at the communication destination according to the communication initiator identification information and the communication destination identification information included in the connection request for the new session,
further wherein,
the session restoration unit and/or the session control unit establishes the session between the terminals or apparatus indicated by the communication initiator identification information and the communication destination identification information which are stored in the session restoration storage area, when a session becomes usable as a result of a disconnection of the new session or another session, whereby restoring the interrupted session.

2. A gateway apparatus according to claim 1, wherein:
in the session importance storage area, restoration requirement information indicating whether restoration is required or not for the interrupted session is further stored in association with the communication initiator identification information and the communication destination identification information; and
the session control unit refers to the session importance storage area based on the communication initiator identification information and the communication destination identification information of the new session included in the connection request for the new session and stores the communication initiator identification information and the communication destination identification information of the selected session in the session restoration storage area when the associated restoration requirement information indicates that restoration is required.

3. A gateway apparatus according to claim 1, wherein
the session restoration unit and/or the session control unit reads the communication initiator identification information and the communication destination identification information stored in the session restoration storage area and transmits a connection request for establishing the session between the terminals or apparatuses indicated by the communication initiator identification information and the communication destination identification information to the terminal or apparatus indicated by the communication initiator identification information and to the terminal or apparatus indicated by the communication destination identification information, thereby restoring the interrupted session.

4. A gateway apparatus according to claim 1, wherein:
the communication initiator identification information and the communication destination identification information of the selected session are deleted from the session status storage area; and
the communication initiator identification information and the communication destination identification information included in the connection request for the new session are stored in the session status storage area.

5. A gateway apparatus according to claim 1, further comprising:
a session resource storage area in which the number of sessions in progress and the preset number of usable sessions are stored; and
a session monitoring unit monitoring sessions and storing the number of sessions in progress in the session resource storage area, wherein
the session control unit refers to the session resource storage area upon receipt of the connection request for the new session, and interrupts the selected session and establishes the new session when the number of the sessions in progress equals the number of usable sessions.

6. A gateway apparatus according to claim 5, wherein:
the session monitoring unit decrements the number of sessions in progress stored in the session resource table when the new session or another session is released; and
the session restoration unit restores the interrupted session when the number of sessions in progress in the session resource table is smaller than the number of usable sessions.

7. A gateway apparatus according to claim 1, wherein the new session is a session associated with security.

8. A gateway apparatus according to claim 1, wherein
the session control unit, when the connection request for the new session is received, refers to the session importance storage area based on the communication initiator identification information and the communication destination identification information included in the connection request to obtain the degree of importance of the new session, and interrupts the selected session having a low degree of importance and establishes a connection for the new session when the degree of importance of the new session is the maximum or higher than a predetermined reference.

9. A gateway apparatus according to claim 8, wherein:
the session control unit receives the connection request for the new session from the terminal for security monitoring, the connection request including an identification information of the terminal as the communication initiator identification information and an identification information of a security center as the communication destination identification information;
a first degree of importance that is the highest importance is stored in the session importance storage area in association with the communication initiator identification information indicating the terminal and the communication destination identification information indicating the security center; and
the session between the terminal and the security center is established with priority.

10. A gateway apparatus according to claim 9, wherein:
a second degree of importance is stored in the session importance storage area in association with communication initiator identification information indicating a terminal for video display or a set-top box and communication destination identification information indicating a server distributing a video stream; and
the second degree of importance is set lower than the first degree of importance and higher than the degrees of importance of other sessions.

11. A gateway apparatus according to claim 9, wherein:
a third degree of importance is stored in the session importance storage area in association with communication initiator identification information indicating a terminal for holding a television conference and communication destination identification information indicating a predetermined conference server;
a fourth degree of importance is stored in the session importance storage area in association with communication initiator identification information indicating a terminal for audio-visual communication and communication destination identification information indicating a predetermined terminal; and
the third and fourth degrees of importance are set lower than the first degree of importance and higher than the degrees of importance of other sessions.
